(19) United States
(12) Patent Application Publication
(10) Pub. No.: US 2008/0129658 A1
(43) Pub. Date: Jun. 5, 2008

(54) DRIVING APPARATUS OF PLASMA DISPLAY PANEL AND DRIVING METHOD THEREOF

(76) Inventor: Kwang-hyun Baek, Suwon (KR)

Correspondence Address: CHRISTIE, PARKER & HALE, LLP, PO BOX 7068, PASADENA, CA, 91109-7068, US

(21) Appl. No.: 11/946,697

(22) Filed: Nov. 28, 2007

(30) Foreign Application Priority Data
Nov. 30, 2006 (KR) 10-2006-0120138

(51) Int. Cl. G09G 3/28

(52) U.S. Cl. 345/63

(57) ABSTRACT

A method for driving a plasma display panel having discharge gaps formed by a plurality of first electrodes and a plurality of second electrodes, the method including: measuring a load ratio of an input video signal inputted to the plasma display panel; applying a greatest number of discharge pulses with a maximum gradient to the first electrodes and the second electrodes if the load ratio of the video signal is less than the threshold value; and reducing a luminance of the plasma display panel by gradually adjusting the gradient of at least one of the sustain discharge pulses to a lower inclination and/or declination level (or a gentle level).

### CROSS-REFERENCE TO RELATED APPLICATIONS

This application claims priority to and the benefit of Korean Patent Application No. 10-2006-0120138, filed on Nov. 30, 2006, in the Korean Intellectual Property Office, the entire content of which is incorporated herein by reference.

### BACKGROUND

1. Field of the Invention

The present invention relates to a plasma display panel, and more particularly, to a driving apparatus of a plasma display panel.

2. Discussion of Related Art

As compared with other flat panel displays, such as a liquid crystal display (LCD) and a field emission display (FED), a plasma display panel (PDP) is a flat panel display that has relatively high luminance and luminescence efficiency and a relatively wider viewing angel. Accordingly, the plasma display panel has come into the spotlight as a display device capable of replacing a conventional cathode ray tube (CRT) display.

The plasma display panel (PDP) is a flat panel display that displays letters or an image using plasma generated during the gas discharge process, and it has from tens to millions of pixels that are arranged in a matrix type according to its size. A plasma display panel can be categorized as a DC-type plasma display panel or an AC-type plasma display panel according to the waveform of a driving voltage to be applied to the plasma display panel, and the structure of its discharge cells.

In a DC-type plasma display panel, an electric current may flow in a discharge gap while a voltage is applied to an electrode of the DC-type plasma display panel because the electrode of the DC-type plasma display panel is not insulated, and therefore resistances are needed to limit a flow of the electric current. By contrast, an AC-type plasma display panel can limit a flow of an electric current by a formation of spontaneous capacitance components because its electrode is covered with a dielectric layer, and therefore the life span of the AC-type plasma display panel is longer than that of the DC-type plasma display panel since the electrode is protected from impacts with ions generated during a discharge process.

FIG. 1 is a partial perspective view showing an AC-type plasma display panel.

As shown in FIG. 1, a scan electrode 4 and a sustain electrode 5, arranged in a pair covered with a dielectric layer 2 and a passivation film 3, are formed in parallel on a glass substrate 1. A plurality of address electrodes 8 covered with an insulator layer 7 are formed on a glass substrate 6. A barrier rib 9 is formed in parallel with address electrodes 8 on the insulator layer 7 and is arranged between the address electrodes 8. Phosphors 10 are formed on a surface of the insulator layer 7 and on both sides of the barrier rib 9. The glass substrates 1, 6 are arranged to face each other with the discharge gap 11 therebetween, and the scan electrode 4 and the sustain electrode 5 are arranged to cross the address electrodes 8. Discharge gaps arranged at crossings of the address electrode 8 and the scan electrode 4 arranged in a pair and the address electrode 8 and the sustain electrode 5 arranged in a pair form a discharge cell 12.

FIG. 2 is a diagram showing an electrode array of the plasma display panel.

As shown in FIG. 2, the electrodes of the plasma display panel are arranged in an m×n matrix. More particularly, address electrodes (A1-Am) are arranged in a column (or vertical) direction. Scan electrodes (Y1-Yn) and sustain electrodes (X1-Xn) are alternately and periodically arranged in a row (or horizontal) direction. The discharge cell 12 as shown in FIG. 2 corresponds to the discharge cell 12 as shown in FIG. 1.

A driving method for the above described AC-type plasma display panel is carried out during a reset period, an addressing period, and a sustain period that divide the entire driving time of the driving method according to the operation changes.

The reset period is a period for resetting each cell so that an addressing operation in the cells can be easily performed. The addressing period is a period for performing an operation in which wall charges are stored by selecting which cells are turned on or off in the panel, followed by applying an address voltage to the turned-on cells (addressed cells). The sustain period is a period for performing discharge to actually display an image in the addressed cells by applying a sustain pulse to the addressed cells.

FIG. 3 is a diagram showing a method for displaying gray levels of the plasma display panel.

As shown in FIG. 3, the plasma display panel display gray levels by dividing one frame (1 TV field) into a plurality of subfields and performing time-sharing control. Each of the subfields is carried out during a reset period, an addressing period and a sustain period, as described above.

One frame is divided into eight subfields to realize 256 gray levels, as shown in FIG. 3. Each of the subfields (SF1-SF8) is carried out during reset periods (not shown), address periods (A1-A8) and sustain periods (S1-S8), and the sustain periods (S1-S8) corresponding to light emission periods (1 T, 2 T, 4 T, . . . , 128 T) have duration ratios of 1:2:4:8:16:32:64:128.

Here, in order to realize 3 gray levels, discharge cells are discharged in a subfield (SF1) having a 1 T light emission period and a subfield (SF2) having a 2 T light emission period and the sum of the discharged periods is 3 T. A screen having 256 gray levels is displayed by combining subfields having different light emission periods using the above method. Here, one frame is divided into a plurality of subfields according to the ratios of the sustain periods, and the subfields are combined to display gray levels. That is, a sustain period of each of the subfields actually has the different number of sustain discharge pulses (the number of sustain pulses), and the gray levels are displayed by combinations of the sustain discharge pulses.

Also, an automatic power control (APC) method is generally used to control a consumed power of the plasma display panel. The APC method is a method for adjusting the number of the total sustain discharge pulses in one frame according to a load ratio of the video signal to be inputted. That is, the input video signal has a high load ratio (namely, power consumption is high since the entire screen is bright in this case), then the power consumption is reduced by reducing the number of the total sustain discharge pulses in one frame. By contrast, if the input video signal has a low load ratio (namely, power consumption is not high since the entire screen is dark in this case), then the number of the total sustain discharge pulses is increased in one frame. Here, the APC method is carried out in several procedures (or levels) according to the load ratio of the input video signal, and the number of the sustain discharge pulses is determined in advance to correspond to these several procedures.

FIG. 4 is a diagram showing one embodiment of a screen displayed with a video signal that has a low load ratio.

Referring to FIG. 4, the screen has a window pattern having a load ratio of 1%, and, in this case, one frame has the greatest number of sustain discharge pulses, as described above.

As shown in FIG. 4, if a load ratio of the screen is about 1%, then the screen having the window pattern exhibits the maximum luminance since power consumption is not excessive even if the screen is driven with the greatest number of the sustain discharge pulses.

In this case, the phosphors corresponding to some regions of the screen may be deteriorated since an excessive amount of voltage may be applied to these phosphors by maintaining sustain discharges in these regions of the screen, and therefore a life span of the panel is adversely affected due to residual images in the screen.

### SUMMARY OF THE INVENTION

Aspects of embodiments of the present invention are directed to a driving apparatus of a plasma display panel and/or a driving method thereof capable of improving luminance efficiency of a peak data and/or reducing (or preventing) deterioration of a phosphor and a driving method thereof.

Aspects of embodiments of the present invention are directed to a driving apparatus of a plasma display panel and/or a driving method thereof capable of improving (or maximizing) a peak luminance efficiency and/or reducing (or preventing) deterioration in a screen by modifying a gradient of a sustain discharge pulse applied during a sustain period to adjust a level of discharge between a scan electrode (Y) and a sustain electrode (X) during the sustain period.

An embodiment of the present invention provides a method for driving a plasma display panel having discharge gaps formed by a plurality of first electrodes and second electrodes, the method including: measuring a load ratio of an input video signal inputted to the plasma display panel; applying a greatest number of discharge pulses with a maximum gradient to the first electrodes and the second electrodes if the load ratio of the video signal is less than the threshold value; and reducing a luminance of the plasma display panel by gradually adjusting the gradient of at least one of the sustain discharge pulses to a lower inclination and/or declination level (or a gentle level).

Another embodiment of the present invention provides a driving apparatus of a plasma display panel for displaying an image corresponding to an input video signal by dividing one frame of the image into a plurality of subfields and displaying gray levels according to combinations of the subfields, the image being displayed in the plasma display panel corresponding to the input video signal, the driving apparatus including: an automatic power controller for measuring a load ratio corresponding to data of the one frame of the image of the input video signal; a scan sustain drive controller for generating a control signal for controlling a number and a gradient of sustain discharge pulses according to the load ratio measured by the automatic power controller; and a scan sustain driver for driving the plasma display panel to correspond to the control signal generated by the scan sustain drive controller, wherein the scan sustain drive controller applies a greatest number and a maximum gradient of the sustain discharge pulses to the first electrodes and the second electrodes if the load ratio of the video signal is less than a threshold value, and then gradually adjusts the gradient of at least one of the sustain discharge pulses to a lower inclination and/or declination level (or a gentle level).

Another embodiment of the present invention provides a plasma display panel including: a driving apparatus for displaying an image corresponding to an input video signal by dividing one frame of the image into a plurality of subfields and displaying gray levels according to combinations of the subfields, the image being displayed in the plasma display panel corresponding to the input video signal, wherein the driving apparatus includes: an automatic power controller for measuring a load ratio corresponding to data of the one frame of the image of the input video signal; a scan sustain drive controller for generating a control signal for controlling a number and a gradient of sustain discharge pulses according to the load ratio measured by the automatic power controller; and a scan sustain driver for driving the plasma display panel to correspond to the control signal generated by the scan sustain drive controller, wherein the scan sustain drive controller applies a greatest number and a maximum gradient of the sustain discharge pulses to the first electrodes and the second electrodes if the load ratio of the video signal is less than a threshold value, and then gradually adjusts the gradient of at least one of the sustain discharge pulses to a lower inclination and/or declination level (or a gentle level).

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a partial perspective view showing an AC-type plasma display panel.

FIG. 2 is a diagram showing an electrode array of the plasma display panel.

FIG. 3 is a diagram showing a method for displaying gray levels of the plasma display panel.

FIG. 4 is a diagram showing one embodiment of a screen displayed with a video signal having a low load ratio.

FIG. 5 a schematic block view showing a plasma display panel according to an embodiment of the present invention.

FIG. 6 a schematic block view showing a controller of the plasma display panel of FIG. 5 according to an embodiment of the present invention.

FIG. 7 is a graph showing a change in a luminance according to a change in a gradient of a sustain discharge pulse according to an embodiment of the present invention.

FIGS. 8A, 8B, and 8C are diagrams showing examples of changes in gradients of sustain discharge pulses according to one embodiment of the present invention.

FIG. 9 is a diagram showing an energy recovery circuit for applying a sustain discharge pulse voltage (Vs) to a scan electrode or a sustain electrode.

FIGS. 10A and 10B are diagrams showing an optical power according to the increasing gradient of a sustain discharge pulse.

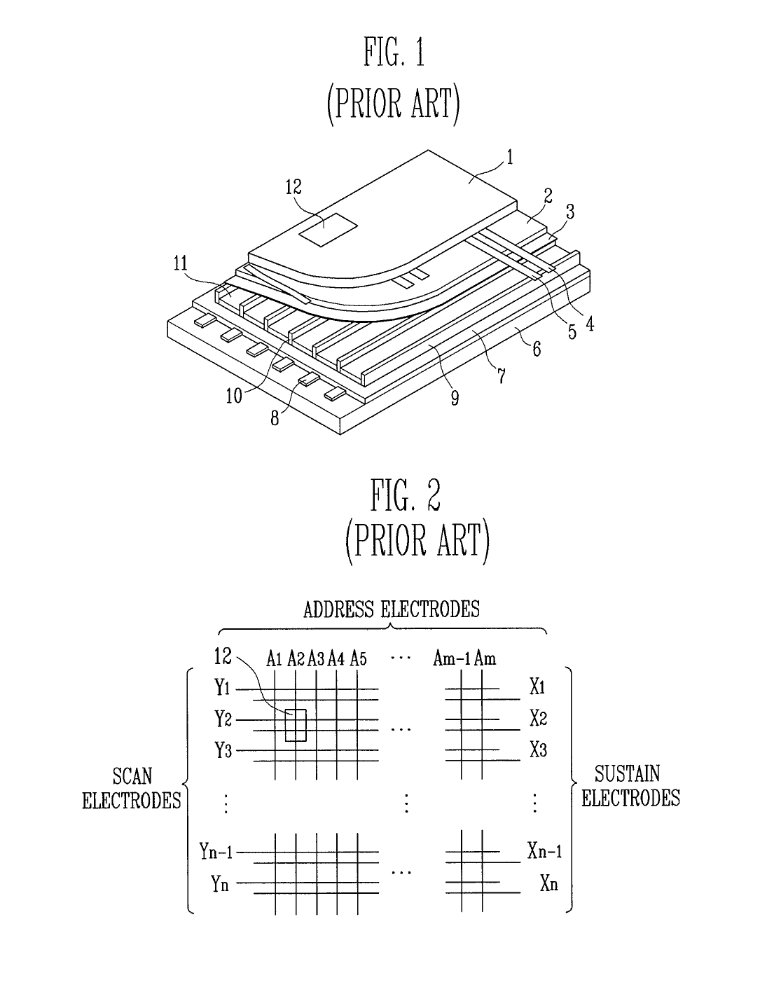

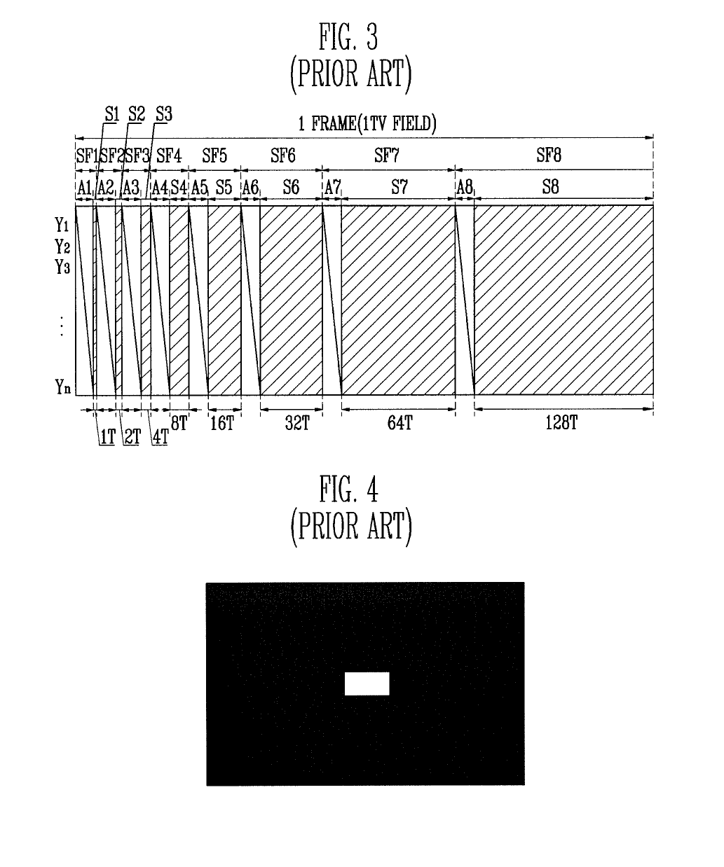

### DETAILED DESCRIPTION

Hereinafter, exemplary embodiments according to the present invention will be described with reference to the accompanying drawings. Here, when one element is described as being connected to another element, one element may be not only directly connected to another element but instead may be indirectly connected to another element via one or more other elements. Also, in the context of the present application, when an element is referred to as being “on” another element, it can be directly on the another element or be indirectly on the another element with one or more intervening elements interposed therebetween. Further, some of the elements that are not essential to the complete description of the invention have been omitted for clarity. Also, like reference numerals refer to like elements throughout.

FIG. 5 a schematic block view showing a plasma display panel according to an embodiment of the present invention.

As shown in FIG. 5, the plasma display panel includes a display panel (or display region) 100, an address driver 200, a scan sustain driver 300 and a controller 400. Here, the driving apparatus of the plasma display panel includes the address driver 200, the scan sustain driver 300 and the controller 400 and does not include the display panel 100.

The display panel 100 includes a plurality of address electrodes (A1-Am) arranged in a column (or vertical) direction; and a plurality of scan electrodes (Y1-Yn) and sustain electrodes (X1-Xn) alternately and periodically arranged in a row (or horizontal) direction. The address driver 200 receives an address drive control signal from the controller 400 to apply a display data signal for selecting discharge cells to be displayed to each of the address electrodes (A1-Am).

The scan-sustain driver 300 performs a sustain discharge for the selected discharge cells by receiving a control signal from the controller 400 to alternately input a sustain discharge pulse voltage (Vs) to the scan electrodes (Y1-Yn) and the sustain electrodes (X1-Xn). If the scan-sustain driver 300 according to an embodiment of the present invention uses an energy recovery circuit to apply the sustain discharge pulse voltage (Vs) to the scan electrodes (Y1-Yn) and the sustain electrodes (X1-Xn), then the light generated in the sustain discharge is controlled by applying a gradient for applying the sustain discharge pulse voltage (Vs) in a different level according to the APC level.

The specific method for controlling a radiation intensity of the sustain discharge according to the APC level may be carried out by controlling a radiation intensity by controlling a turned-on time of a switch which is used for increasing (or incrementing) the sustain discharge pulse voltage (Vs) in the energy recovery circuit, as described in more detail below.

The controller 400 receives R, G and B video signals and a synchronizing signal from the outside to divide one frame into several subfields, and each of the subfields is divided into a reset period, an address period and a sustain period to drive a plasma display panel. Here, the controller 400 supplies a control signal (or a necessary control signal) to an address driver 200 and a scan-sustain driver 300 by adjusting the number of sustain discharge pulses entering the sustain period of the subfields in the one frame.

The controller 400 according to the embodiment of the present invention calculates an APC level of the video signal to be inputted, generates a control signal to control an increasing gradient of a sustain discharge pulse voltage (Vs), and then applies the sustain discharge pulse voltage (Vs) according to the APC level. Such a control signal is transmitted to a scan-sustain driver 300.

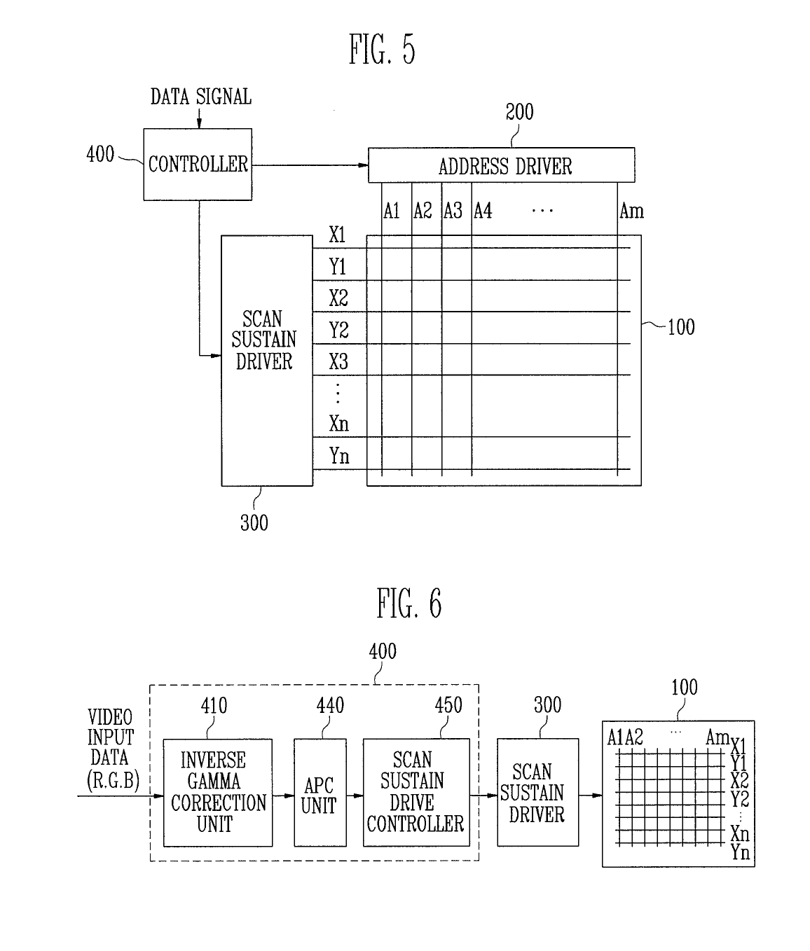

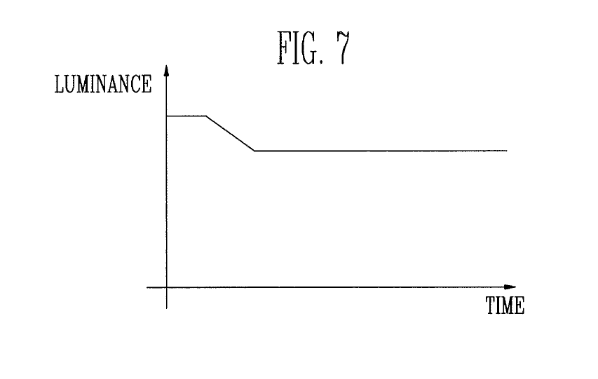

FIG. 6 a schematic block view showing a controller of the plasma display panel of FIG. 5 according to an embodiment of the present invention.

As shown in FIG. 6, the controller 400 includes an inverse gamma correction unit 410, an automatic power control (APC) unit 440, and a scan sustain drive controller 450.

The inverse gamma correction unit 410 maps n-bits of R, G and B video input data, which are currently inputted video input data, in an inverse gamma curve and corrects them with m-bits of video signal (m≧n). In a exemplary plasma display panel, n is 8 and m ranges from 10 or 12.

Here, the video signal inputted to the inverse gamma correction unit 410 is a digital signal so that it is necessary to convert an analog video signal to a digital video signal using an analog digital converter if the analog video signal is inputted to the plasma display panel. Also, the inverse gamma correction unit 410 may include a lookup table for storing a data corresponding to the inverse gamma curve to map a video signal, or a logic circuit for generating a data corresponding to the inverse gamma curve in a logic operation.

The APC unit 440 uses a video data, outputted from the inverse gamma correction unit 410, to detect a load ratio, calculates an APC level according to the detected load ratio, and computes the number of sustain pulses (the number of sustain discharge pulses) corresponding to the calculated APC level to output the corresponding sustain pulses.

That is, the APC unit 440 computes the total number of sustain pulses in every frame according to the APC level, and calculates the number of sustain pulses of each of the subfields corresponding to the computed sustain pulses. The APC unit 440 calculates an average signal level (ASL) in every frame to determine the number of the sustain pulses, and is represented by the following Equation 1.

$$ASL = {\sum }_{x = 1}^{N} {\sum }_{y = 1}^{M} \frac{{R}_{x , y} + {G}_{x , y} + {B}_{x , y}}{3 \times N \times M} \qquad Equation 1$$

In the Equation 1, Rx,y, Gx,y and Bx,y represent R, G and B gray level values in x and y coordinates, respectively, and N and M represent a width and a length of a frame, respectively. The APC unit 440 determines an APC level in consideration of the luminance and the power consumption by using the average signal level (ASL) calculated as in the Equation 1, and determines a different number of sustain pulses (the different number of sustain discharge pulses) in every frame of the input video signal in accordance with the determined APC level.

The APC unit 440 increases the number of sustain pulses when the power consumption is low because the average signal level calculated in the Equation 1 is low, namely, if an APC level is low (if a load ratio is low). By contrast, the APC unit 440 decreases the number of sustain pulses (the number of sustain discharge pulses) when power consumption is high because the average signal level is high (namely, if the APC level is high).

In the embodiment of the present invention, the APC level is determined by using the average signal level (ASL), but the present invention is not limited thereto. Other suitable methods may be also used herein, for example, determining an APC level by using on/off information of each of the subfield data.

In the embodiment of the present invention, the APC unit 440 also uses the data, outputted from the inverse gamma correction unit 410, to determine the APC level, but this is just one embodiment and not limited thereto.

As described above, the APC unit 440 increases the number of sustain discharge pulses when power consumption is low because a load ratio is low, and decreases the number of sustain discharge pulses when power consumption is high because the average signal level is high.

That is, if the screen has a load ratio of about 1%, the screen is driven by the maximum number of sustain discharge pulses, and therefore the screen exhibits the maximum luminance because power consumption is not high.

In this case, the phosphors corresponding to some regions of the screen may be deteriorated since an excessive amount of voltage may be applied to these phosphors by maintaining sustain discharges in these regions of the screen, and therefore a life span of the panel is adversely affected due to residual images in the screen.

In order to solve the above problem, an embodiment of the present invention is characterized in that if the load ratio of the screen is less than the threshold value when an average signal level (ASL) is calculated in every frame, the number of sustain discharge pulses is set to the greatest values and the gradient is set to the maximum value to exhibit a peak luminance, and then a peak luminance efficiency is maximized; however, deterioration of phosphors is reduced (or prevented) and a life span of the screen is increased by modifying a luminance by gradually adjusting a gradient of the sustain discharge pulse to a lower level.

Here, in one embodiment, the threshold value ranges from 1 to 10% of the load ratio of the video signal, and may be adjusted by a selection (or a random selection) of one or more users.

Also, the gradient of the sustain discharge pulse may be adjusted by adjusting ERC timing to induce hard switching, and a discharge characteristic is varied according to the gradient.

That is, the discharge becomes stronger to exhibit a higher luminance as the gradient of the sustain discharge pulse approaches 1, and the discharge becomes weaker to exhibit a lower luminance as the gradient of the sustain discharge pulse approaches 0.

If the load ratio of the screen is less than the threshold value, such a characteristic is used to set the number of sustain discharge pulses to the greatest values and the gradient to the maximum value, thereby to exhibit a peak luminance, and then if the gradient of the sustain discharge pulse is adjusted to a relatively gentle level or a lower inclination and/or declination level (or to a lower degree of ascent and/or descent) to generate a weaker discharge so as to protect phosphor(s) from deterioration, the phosphor(s) can be protected from deterioration because the luminance is reduced, as shown in FIG. 7.

However, the screen of an embodiment of the present invention is used when the calculated ASL value has a relatively low change width during a period (that may be predetermined), for example, if a still image is sequentially cycled and displayed.

Then, according to one embodiment of the present invention, in a period when the gradient of the sustain discharge pulse is adjusted to a relatively gentle level and/or a lower inclination or declination level (hereafter also referred to as just gentle level) is carried out if the ASL value has a relatively low change width during a period (that may be predetermined), that is, if a load ratio of the screen is less than the threshold value.

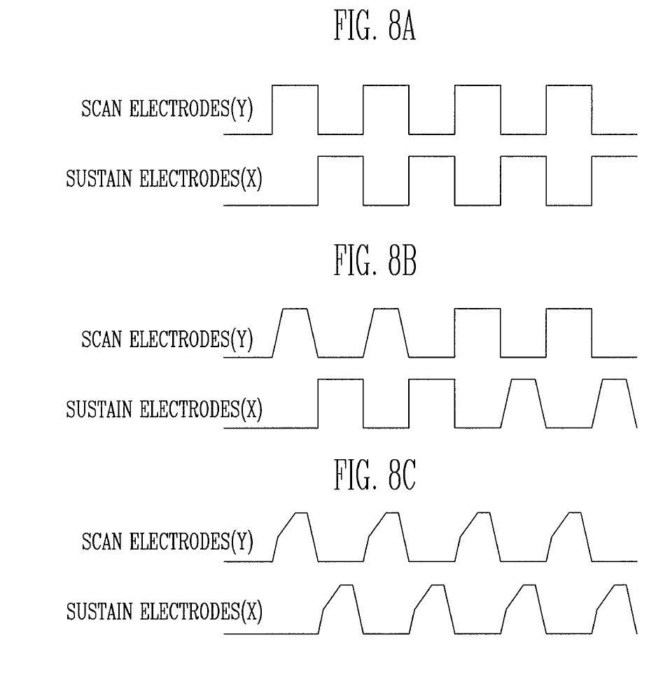

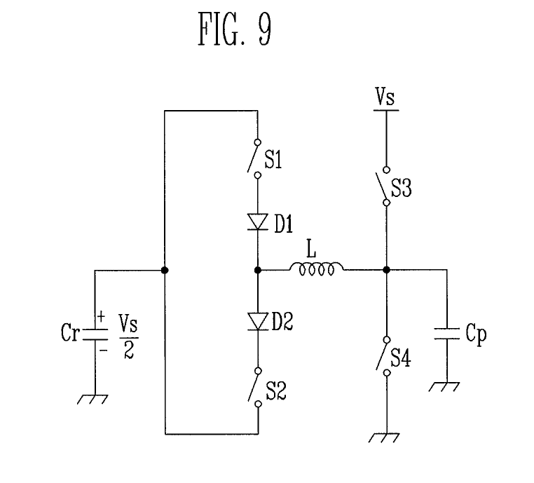

FIG. 7 is a graph showing a change in a luminance according to a change in a gradient of a sustain discharge pulse according to one embodiment of the present invention, and FIGS. 8A, 8B, and 8C are diagrams showing examples of the change in gradients of sustain discharge pulses according to one embodiment of the present invention.

However, for convenience purposes, a case that a load ratio of the screen is less than the threshold value, as described above, will be described in more detail below.

Referring to FIG. 8A, if a load ratio of the screen is less than the threshold value when an average signal level (ASL) is calculated in every frame, the number of sustain discharge pulses, applied to the scan electrodes (Y) and the sustain electrodes (X), is first set to the greatest level, and the gradient is first set to the maximum level to exhibit a peak luminance (a), and then the luminance is changed by gradually adjusting a gradient of the sustain discharge pulse to a relatively gentle level.

Referring to FIGS. 8B and 8C, the gradient of the sustain discharge pulse(s), applied to the scan electrodes (Y), is first adjusted to a first gentle level (see FIG. 8B), and then the gradient of the sustain discharge pulse(s), applied to the scan electrodes (Y) and the sustain electrodes (X), is adjusted to a second gentle level that is more gentle (or even lower in degree of ascent and/or descent) than the first gentle level (see FIG. 8C).

That is, the step of adjusting a gradient of the sustain discharge pulse to a gentle level includes: adjusting the gradient of the sustain discharge so that the sustain discharge pulse, applied to the scan electrodes and the sustain electrodes, can have a first gradient; and adjusting the gradient of the sustain discharge so that the sustain discharge pulse, applied to the first electrodes and the second electrodes, can have a second gradient, wherein the second gradient is gentler than the first gradient.

If the gradient of the sustain discharge pulse is adjusted through the procedure as described above, the luminance is changed as shown in FIG. 7, and therefore a peak luminance efficiency may be maximized, deterioration of phosphor(s) may be reduced (or prevented), and a life span of the panel may be also extended.

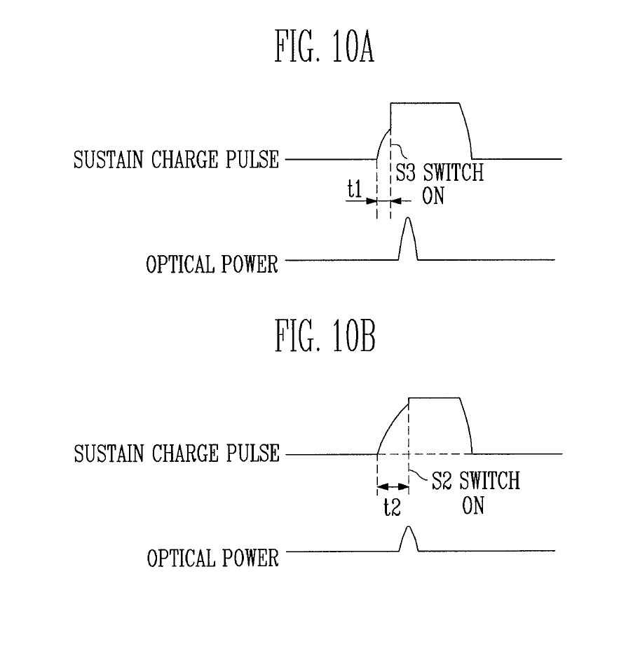

Hereinafter, a method for adjusting a gradient of the sustain discharge pulse will be described with reference to FIG. 9 and FIGS. 10A and 10B.

FIG. 9 is a diagram showing an energy recovery circuit for applying a sustain discharge pulse voltage (Vs) to a scan electrode or a sustain electrode, and FIGS. 10A and 10B are diagrams showing an optical power according to the increasing gradient of a sustain discharge pulse. The energy recovery circuit as shown in FIG. 9 is an energy recovery circuit that recovers and re-uses a reactive power.

In FIG. 9, a switch (S1) is turned on to apply a sustain discharge pulse voltage (Vs) to a sustain electrode or a scan electrode (to which a first terminal or a second terminal of a panel capacitor (Cp) corresponds, as shown in FIG. 9). Once the switch (S1) is turned on, a resonance passage is formed by a capacitor (Cr), an inductor (L) and a panel capacitor (Cp) to increase a voltage of the first terminal (which correspond to the sustain electrode or the scan electrode) of the panel capacitor (Cp) to an adjacent Vs voltage. When the first terminal of the panel capacitor (Cp) is increased to the adjacent Vs voltage, an S2 switch is turned on to clamp a voltage of the first terminal of the panel capacitor (Cp) to the Vs voltage. The sustain discharge pulse voltage (Vs) is applied to the sustain electrode or the scan electrode in this manner.

Here, in one embodiment, an optical power is varied according to the time periods (t1, t2) between the time when the switch (S1) is turned on and the time when the switch (S2) is turned on, as shown in FIGS. 10A and 10B. That is, if a switch (S3) is turned on within a relatively short time (t1) after a switch (S1) is turned on, the sustain discharge pulse has a relatively strong optical power since it is suddenly clamped to the Vs voltage within a very short time, as shown in FIG. 10A. If a switch (S3) is turned on within a relatively long time (t2) after a switch (S1) is turned on, an optical power is outputted at a relatively weak level since a region increasing to the Vs voltage is relatively long due to resonance, as shown in FIG. 10B. Here, it can be derived (or revealed) that the increasing gradient of the sustain discharge pulse is different, as shown in FIGS. 10A and 10B. In the embodiment of the present invention as described above, a method for making the increasing gradient of the sustain discharge pulse voltage different may be realized by adjusting a turned-on time of switches (S1, S2), as shown in FIG. 9 and FIGS. 10A and 10B.

Here, referring back to FIG. 5, in order to adjust an increasing gradient of a sustain discharge pulse voltage to a different level, the scan-sustain drive controller 450 generates a control signal for switch timing and transmits the generated control signal to a scan-sustain driver 300, as described above.

The scan-sustain driver 300 includes an energy recovery circuit, as shown in FIG. 9, and receives a switch control signal according to the APC level from a scan-sustain drive controller 450, and applies the sustain discharge pulse voltage (Vs) to the scan electrodes (Y1-Yn) and the sustain electrodes (X1-Xn) according to the control signal.

For example, as described above, a driving apparatus of a plasma display panel according to an embodiment of the present invention is capable of maximizing (or increasing) a peak luminance efficiency and preventing (or reducing) deterioration in a screen by modifying a gradient of a sustain discharge pulse applied during a sustain period to adjust a level of discharge between a scan electrode (Y) and a sustain electrode (X) during the sustain period.

The description provided herein is just exemplary embodiments for the purpose of illustrations only, and not intended to limit the scope of the invention, so it should be understood that other equivalents and modifications could be made thereto without departing from the spirit and scope of the invention as those skilled in the art would appreciate. Therefore, it should be understood that the present invention has a scope that is defined in the claims and their equivalents.

What is claimed is:

1. A method for driving a plasma display panel having discharge gaps formed by a plurality of first electrodes and a plurality of second electrodes, the method comprising:
measuring a load ratio of an input video signal inputted to the plasma display panel;
applying a greatest number of discharge pulses with a maximum gradient to the first electrodes and the second electrodes if the load ratio of the video signal is less than the threshold value; and
reducing a luminance of the plasma display panel by gradually adjusting the gradient of at least one of the sustain discharge pulses to a lower inclination and/or declination level.

2. The method for driving the plasma display panel according to claim 1, wherein the load ratio of the input video signal is obtained by calculating an average signal level in every frame.

3. The method for driving the plasma display panel according to claim 1, wherein the threshold value ranges from 1 to 10% of the load ratio of the video signal.

4. The method for driving the plasma display panel according to claim 1, wherein a period when the gradient of the at least one of the sustain discharge pulses is adjusted to the lower and/or declination level includes a period when a load ratio of a screen is maintained at a level less than the threshold value.

5. The method for driving the plasma display panel according to claim 1, wherein the gradient of the at least one of the sustain discharge pulses is determined by on-and-off timing of a switch in an energy recovery circuit electrically connected to the first electrodes or the second electrodes.

6. The method for driving the plasma display panel according to claim 1, wherein the adjusting the gradient of the at least one of the sustain discharge pulses to the lower inclination and/or declination level comprises:
adjusting the gradient of a first one of the sustain discharge pulses so that the first one of the sustain discharge pulses, applied to the first electrodes and the second electrodes, has a first gradient; and
adjusting the gradient of a second one of the sustain discharge pulses so that the second one of the sustain discharge pulses, applied to the first electrodes and the second electrodes, has a second gradient.

7. The method for driving the plasma display panel according to claim 6, wherein the second gradient is lower in inclination and/or declination level than the first gradient.

8. A driving apparatus of a plasma display panel for displaying an image corresponding to an input video signal by dividing one frame of the image into a plurality of subfields and displaying gray levels according to combinations of the subfields, the image being displayed in the plasma display panel corresponding to the input video signal, the driving apparatus comprising:
an automatic power controller for measuring a load ratio corresponding to data of the one frame of the image of the input video signal;
a scan sustain drive controller for generating a control signal for controlling a number and a gradient of sustain discharge pulses according to the load ratio measured by the automatic power controller; and
a scan sustain driver for driving the plasma display panel to correspond to the control signal generated by the scan sustain drive controller,
wherein the scan sustain drive controller applies a greatest number and a maximum gradient of the sustain discharge pulses to the first electrodes and the second electrodes if the load ratio of the video signal is less than a threshold value, and then gradually adjusts the gradient of at least one of the sustain discharge pulses to a lower inclination and/or declination level.

9. The driving apparatus of the plasma display panel according to claim 8, wherein the threshold value ranges from 1 to 10% of the load ratio of the video signal.

10. The driving apparatus of the plasma display panel according to claim 8, wherein a period when the gradient of the at least one of the sustain discharge pulses is adjusted to the lower and/or declination level includes a period when a load ratio of a screen is maintained at a level less than the threshold value.

11. The driving apparatus of the plasma display panel according to claim 8, further comprising an energy recovery circuit for controlling a gradient of the sustain discharge pulse by adjusting on-and-off timing of an internal switch of the energy recovery circuit.

12. The driving apparatus of the plasma display panel according to claim 8, wherein the automatic power controller is adapted to obtain the load ratio of the input video signal by calculating an average signal level in the one frame.

13. The driving apparatus of the plasma display panel according to claim 8, wherein the scan sustain drive controller is adapted to adjust the gradient of the at least one of the sustain discharge pulses to the lower inclination and/or declination level by adjusting the gradient of a first one of the sustain discharge pulses so that the first one of the sustain discharge pulses, applied to the first electrodes and the second electrodes, has a first gradient and by adjusting the gradient of a second one of the sustain discharge pulses so that the second one of the sustain discharge pulses, applied to the first electrodes and the second electrodes, has a second gradient.

14. The driving apparatus of the plasma display panel according to claim 13, wherein the second gradient is lower in inclination and/or declination level than the first gradient.

15. A plasma display panel comprising:
a driving apparatus for displaying an image corresponding to an input video signal by dividing one frame of the image into a plurality of subfields and displaying gray levels according to combinations of the subfields, the image being displayed in the plasma display panel corresponding to the input video signal,
wherein the driving apparatus comprises:
an automatic power controller for measuring a load ratio corresponding to data of the one frame of the image of the input video signal;
a scan sustain drive controller for generating a control signal for controlling a number and a gradient of sustain discharge pulses according to the load ratio measured by the automatic power controller; and
a scan sustain driver for driving the plasma display panel to correspond to the control signal generated by the scan sustain drive controller,
wherein the scan sustain drive controller applies a greatest number and a maximum gradient of the sustain discharge pulses to the first electrodes and the second electrodes if the load ratio of the video signal is less than a threshold value, and then gradually adjusts the gradient of at least one of the sustain discharge pulses to a lower inclination and/or declination level.

16. The plasma display panel according to claim 15, wherein the threshold value ranges from 1 to 10% of the load ratio of the video signal.

17. The plasma display panel according to claim 15, wherein a period when the gradient of the at least one of the sustain discharge pulses is adjusted to the lower and/or declination level includes a period when a load ratio of a screen is maintained at a level less than the threshold value.

18. The plasma display panel according to claim 15, further comprising an energy recovery circuit for controlling a gradient of the sustain discharge pulse by adjusting on-and-off timing of an internal switch of the energy recovery circuit.

19. The plasma display panel according to claim 15, wherein the automatic power controller is adapted to obtain the load ratio of the input video signal by calculating an average signal level in the one frame.

20. The plasma display panel according to claim 15, wherein the scan sustain drive controller is adapted to adjust the gradient of the at least one of the sustain discharge pulses to the lower inclination and/or declination level by adjusting the gradient of a first one of the sustain discharge pulses so that the first one of the sustain discharge pulses, applied to the first electrodes and the second electrodes, has a first gradient and by adjusting the gradient of a second one of the sustain discharge pulses so that the second one of the sustain discharge pulses, applied to the first electrodes and the second electrodes, has a second gradient, and wherein the second gradient is lower in inclination and/or declination level than the first gradient.
